(19) United States
(12) Patent Application Publication
(10) Pub. No.: US 2024/0334869 A1
(43) Pub. Date: Oct. 10, 2024

(54) DRIVE SYSTEM HOPPING DETECTION AND CONTROL

(71) Applicant: MILWAUKEE ELECTRIC TOOL CORPORATION, Brookfield, WI (US)

(72) Inventor: Daniel R. Ertl, Kewaskum, WI (US)

(21) Appl. No.: 18/293,597

(22) PCT Filed: Aug. 10, 2022
(86) PCT No.: PCT/US2022/039985

§ 371 Date: Jan. 30, 2024

Related U.S. Application Data
(60) Provisional application No. 63/231,684, filed on Aug. 10, 2021.

(51) Int. Cl. A01D 34/69; A01D 101/00; B60L 50/60

(52) U.S. Cl. CPC A01D 34/69; A01D 2101/00; B60L 50/60; B60L 2200/40

(57) ABSTRACT

A walk-behind lawnmower comprising one or more wheels, one or more cutting blades, a motor configured to rotate the one or more cutting blades, a sensor configured to sense an acceleration of the motor, and a controller coupled to the motor and the sensor. The controller is configured to receive, from the sensor, a signal indicative of the acceleration of the motor, determine, based on the signal, whether an amplitude of the acceleration of the motor is greater than or equal to an amplitude threshold, and increment, in response to the amplitude being greater than or equal to the amplitude threshold, a hopping counter. The controller is configured to determine whether the hopping counter is greater than or equal to a hopping threshold, and disable, in response to the hopping counter being greater than or equal to the hopping threshold, operation of the motor.

### RELATED APPLICATIONS

This application claims the benefit of U.S. Provisional Patent Application No. 63/231,684, filed Aug. 10, 2021, the entire content of which is hereby incorporated by reference.

### FIELD

The present disclosure relates to lawnmowers, and more particularly to lawnmowers having one or more wheels driven by one or more motors.

### SUMMARY

A lawnmower under normal operation moves along the ground with one or more driven wheels making consistent contact with the ground. The drive system drives the wheels with a constant torque output and rotational speed. If the lawnmower encounters surface changes in the terrain, user forces act against the direction of motion of the lawnmower, or the lawnmower makes contact with an object in the path of the lawnmower, one or more of the drive wheels may leave the ground, resulting in a loss of traction for those given wheels. The load decrease on the given wheels and, thereby, the drive system, causes the drive system to accelerate. The wheels speed up due to the drive system acceleration. When the wheels once again contact the ground, the drive system correspondingly decelerates as a result.

The disclosure provides, in one aspect, a lawnmower including one or more sensors detecting a parameter of the lawnmower corresponding to an acceleration of a drive motor of the lawnmower. A controller determines if a drive system of the lawnmower has lost traction regarding one or more wheels of the lawnmower that are driven by the drive motor. The controller then determines a hopping condition has occurred. In response to a determination of a hopping condition, the controller stops the drive motor and/or decouples the drive motor from one or more components of the drive system. Some embodiments, additionally or alternatively, include the controller adjusting an amount of power applied to the motor to counter acceleration/deceleration cycles caused by the hopping condition.

One embodiment provides a walk-behind lawnmower including a lawnmower housing, one or more wheels, one or more cutting blades, a motor configured to rotate the one or more wheels, a sensor configured to sense an acceleration of the motor, and a controller coupled to the motor and the sensor. The controller is configured to receive, from the sensor, a signal indicative of the acceleration of the motor, determine, based on the signal, whether an amplitude of the acceleration of the motor is greater than or equal to an amplitude threshold, and increment, in response to the amplitude being greater than or equal to the amplitude threshold, a hopping counter. The controller is configured to determine whether the hopping counter is greater than or equal to a hopping threshold, and disable, in response to the hopping counter being greater than or equal to the hopping threshold operation of the motor.

Another embodiment provides a method of operating a walk-behind lawnmower. The method includes receiving, from a sensor, a signal indicative of an acceleration of a motor, determining, based on the signal, whether an amplitude of the acceleration of the motor is greater than or equal to an amplitude threshold, and incrementing, in response to the amplitude being greater than or equal to the amplitude threshold, a hopping counter. The method includes determining whether the hopping counter is greater than or equal to a hopping threshold and disabling, in response to the hopping counter being greater than or equal to the hopping threshold, operation of the motor.

Another embodiment provides a walk-behind lawnmower including a lawnmower housing, one or more wheels, one or more cutting blades, a motor configured to rotate the one or more wheels, a sensor configured to sense an acceleration of the motor, and a controller coupled to the motor and the sensor. The controller is configured to receive, from the sensor, a signal indicative of the acceleration of the motor, determine, based on the signal, an acceleration amplitude profile, determine whether the acceleration amplitude profile indicates a hopping condition of the one or more wheels, and increment, in response to the acceleration amplitude profile indicating a hopping condition of the one or more wheels, a hopping counter. The controller is configured to determine whether the hopping counter is greater than or equal to a hopping threshold, and disabling, in response to the hopping counter being greater than or equal to the hopping threshold, operation of the motor.

Other features and aspects of the disclosure will become apparent by consideration of the following detailed description and accompanying drawings.

### BRIEF DESCRIPTION OF THE DRAWINGS

FIG. 1 is a lawnmower, according to some embodiments.

FIG. 2 is a block diagram of a control system for the lawnmower of FIG. 1, according to some embodiments.

FIG. 3 is a perspective view of a battery pack, according to some embodiments.

FIG. 4 is a block diagram of a control system for the battery pack of FIG. 3, according to some embodiments.

FIG. 5 is a schematic representation of a wheel hopping phenomenon accompanied by a corresponding line graph depicting motor acceleration versus time, according to some embodiments.

FIG. 6A is a first portion of a flowchart schematically representing a drive system hopping detection and control method/controller operation, according to some embodiments.

FIG. 6B is a second portion of the flowchart starting in FIG. 6A.

FIG. 6C is a third portion of the flowchart starting in FIG. 6A

FIG. 7A is a line graph depicting motor acceleration versus time testing data for the drive system hopping detection and control method/controller operation of FIGS. 6A-6C, according to some embodiments.

FIG. 7B is a line graph depicting detected hopping condition counts versus time testing data for the drive system hopping detection and control method/controller operation of FIGS. 6A-6C, according to some embodiments.

FIG. 7C is a line graph depicting a blanking counts versus time testing data for the drive system hopping detection and control method/controller operation of FIGS. 6A-6C, according to some embodiments.

FIG. 8A is a first portion of a flowchart schematically representing a drive system hopping detection and control method/controller operation, according to some embodiments.

FIG. 8B is a second portion of the flowchart starting in FIG. 8A.

FIG. 8C is a third portion of the flowchart starting in FIG. 8A.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

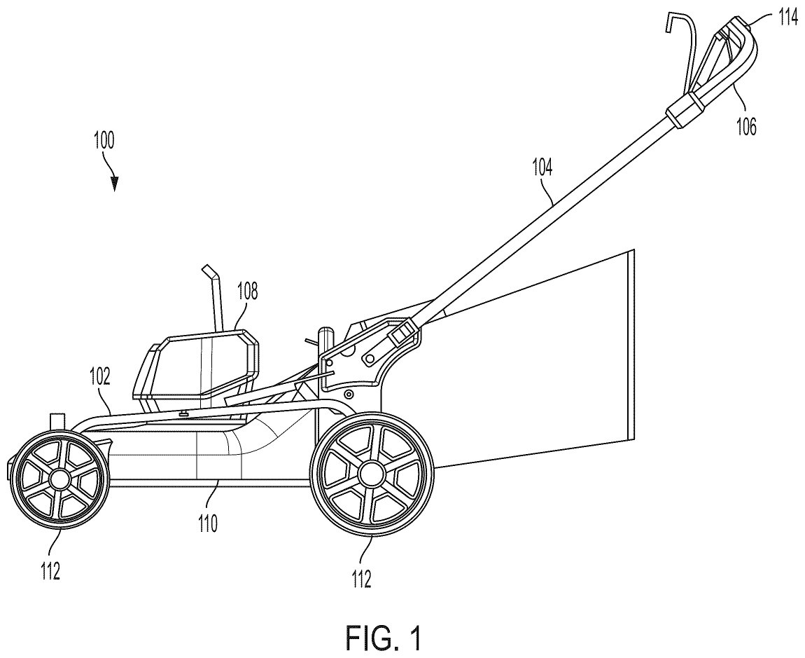

FIG. 1 illustrates a lawnmower 100, according to one embodiment. The lawnmower 100 includes a housing 102 and a handle 106 coupled to the housing 102 by support beams 104. The handle 106 includes a one or more paddles 114 (e.g., triggers). A motor housing 108 is coupled to an upper portion of the housing 102 and houses a motor configured to drive cutting blades 110. In some embodiments, the motor receives power when the one or more paddles 114 are actuated. The blades 110 are coupled to a lower portion of the housing 102. The lawnmower 100 includes a plurality of wheels 112 driven by the motor 280. In some embodiments, either the plurality of wheels 112 or the cutting blades 110 are driven by an auxiliary motor within the motor housing 108. In some embodiments, the lawnmower 100 is configured to be pushed or followed by an operator holding the handle 106 (e.g., a walk-behind lawnmower).

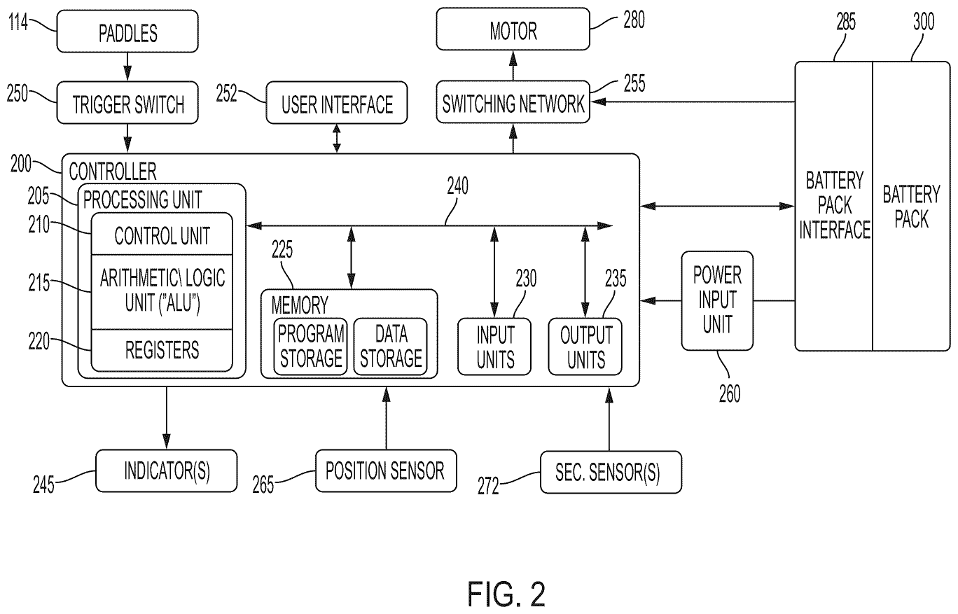

A controller 200 for the lawnmower 100 (e.g., a lawnmower controller) is illustrated in FIG. 2. The controller 200 is electrically and/or communicatively connected to a variety of modules or components of the lawnmower 100. For example, the illustrated controller 200 is connected to indicators 245, a user interface 252, a position sensor 265, secondary sensor(s) 272 (e.g., a voltage sensor, a temperature sensor, a current sensor, etc.), the paddles 114 (via a trigger switch 250), a power switching network 255, a power input unit 260, and a battery pack interface 285.

The controller 200 includes a plurality of electrical and electronic components that provide power, operational control, and protection to the components and modules within the controller 200 and/or the lawnmower 100. For example, the controller 200 includes, among other things, a processing unit 205 (e.g., a microprocessor, an electronic processor, an electronic controller, a microcontroller, or another suitable programmable device), a memory 225, input units 230, and output units 235. The processing unit 205 includes, among other things, a control unit 210, an arithmetic logic unit (“ALI”) 215, and a plurality of registers 220 (shown as a group of registers in FIG. 2), and is implemented using a known computer architecture (e.g., a modified Harvard architecture, a von Neumann architecture, etc.). The processing unit 205, the memory 225, the input units 230, and the output units 235, as well as the various modules connected to the controller 200 are connected by one or more control and/or data buses (e.g., common bus 240). The control and/or data buses are shown generally in FIG. 2 for illustrative purposes. The use of one or more control and/or data buses for the interconnection between and communication among the various modules and components would be known to a person skilled in the art of the embodiments described herein.

The memory 225 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 225 and executes software instruction that are capable of being stored in a RAM of the memory 225 (e.g., during execution), a ROM of the memory 225 (e.g., on a generally permanent basis), or another non-transitory computer readable medium such as another memory or a disc. Software included in the implementation of the lawnmower 100 can be stored in the memory 225 of the controller 200. The software includes, for example, firmware, one or more applications, program data, filters, rules, one or more program modules, and other executable instructions. The controller 200 is configured to retrieve from the memory 225 and execute, among other things, instructions related to the control processes and methods described herein. In other embodiments, the controller 200 includes additional, fewer, or different components.

The controller 200 drives the motor 280 to rotate the blades 110 and/or the plurality of wheels 112 in response to a user's actuation of the paddles 114. Depression of the paddles 114 actuate the trigger switch 250. The trigger switch 250 outputs a signal to the controller 200 to drive the motor 280, and therefore the blades 110 and/or the plurality of wheels 112. In some embodiments, the controller 200 controls a power switching network 255 (e.g., a FET Switching bridge) to drive the motor 280. For example, the power switching network 255 may include a plurality of high side switching elements (e.g., FETs) and a plurality of low side switching elements. The controller 200 may control each FET of the plurality of high side switching elements and the plurality of low side switching elements to drive each phase of the motor 280. When the paddles 114 are released, the controller 200 may apply a braking force to the motor 280. For example, the power switching network 255 may be controlled to more quickly deaccelerate the motor 280. In some embodiments, the controller 200 drives an auxiliary motor to drive the plurality of wheels 112. For example, the motor 280 is controlled to drive the blades 110, and the auxiliary motor is controlled to drive the plurality of wheels 112. The auxiliary motor may be controlled via a second power switching network.

The position sensor 265 (e.g., a Hall effect sensor or other position sensor) detects one or more of the rotational position, velocity, and acceleration of the motor 280. In some embodiments, sensorless motor control is employed and Hall effect sensors are not needed. The secondary sensors 272 may include additional sensors for monitoring a condition of the motor 280, such as speed sensors, accelerometers, voltage sensors, current sensors, temperature sensors, and the like.

The indicators 245 are also connected to the controller 200 and receive control signals from the controller 200 to turn on and off or otherwise convey information based on different states of the lawnmower 100. The indicators 245 include, for example, one or more light-emitting diodes (LEDs), or a display screen. The indicators 245 can be configured to display conditions of, or information associated with, the lawnmower 100. For example, the indicators 245 may indicate whether a hopping condition is detected, as described below in more detail. In some embodiments, the indicators 245 indicate whether an operator of the lawnmower 100 should perform a power cycle. The user interface 252 is a device that interacts with an operator of the lawnmower 100 to provide commands to the controller 200. For example, the user interface 252 may include a touchscreen, buttons, dials, switches, or a combination thereof to receive user inputs. In some embodiments, the indicator s245 are integrated into the user interface 252.

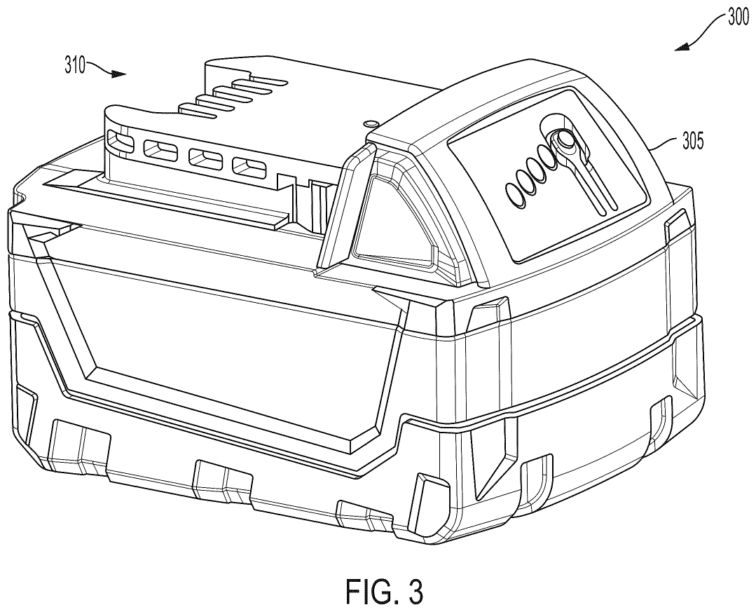

The battery pack interface 285 is connected to the controller 200 and is configured to couple with a battery pack 300 (shown in FIG. 3). The battery pack interface 285 includes a combination of mechanical (e.g., a battery pack receiving portion) and electrical components configured to and operable for interfacing (e.g., mechanically, electrically, and communicatively connecting) the lawnmower 100 with the battery pack 300. The battery pack interface 285 is coupled to the power input unit 260. The battery pack interface 285 transmits the power received from the battery pack 300 to the power input unit 260. The power input unit 260 includes active and/or passive components (e.g., voltage step-down controllers, voltage converters, rectifiers, filters, etc.) to regulate or control the power received through the battery pack interface 285 and to the controller 200. In some embodiments, the battery pack interface 285 is also coupled to the power switching network 255. The operation of the power switching network 255, as controlled by the controller 200, determines how power is supplied to the motor 280.

FIG. 3 illustrates an example battery pack 300 that includes a housing 305 and an interface portion 310 for connecting the battery pack 300 to a device, such as the lawnmower 100. While embodiments described herein primarily relate to a battery-powered lawnmower, in other embodiments, the lawnmower 100 may be a gasoline-powered lawnmower, a corded lawnmower, or another type of lawnmower.

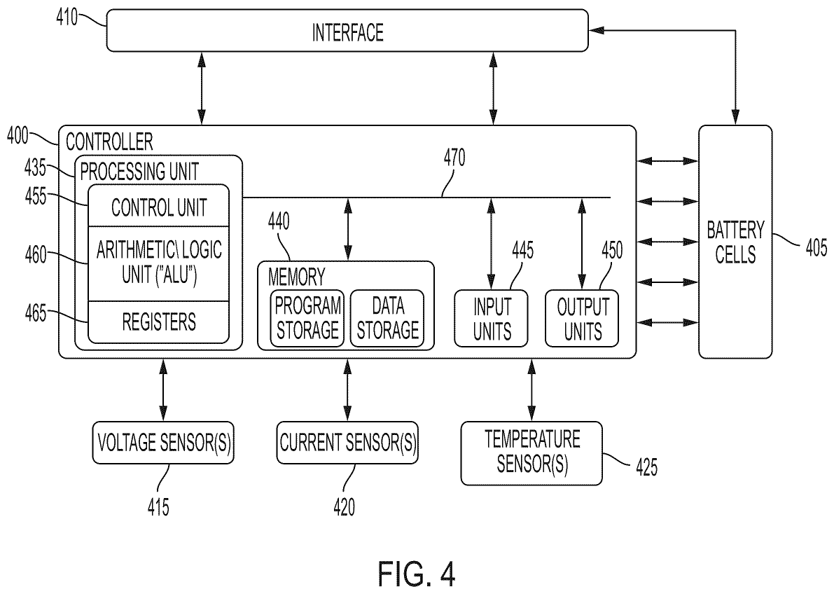

FIG. 4 illustrates a control system for the battery pack 300. The control system includes a battery pack controller 400. The battery pack controller 400 is electrically and/or communicatively connected to a variety of modules or components of the battery pack 300. For example, the illustrated battery pack controller 400 is connected to one or more battery cells 405 and an interface 410 (e.g., the interface portion 310 of the battery pack 300 illustrated in FIG. 3). The battery pack controller 400 is also connected to one or more voltage sensors or voltage sensing circuits 415, one or more current sensors or current sensing circuits 420, and one or more temperature sensors or temperature sensing circuits 425. The battery pack controller 400 includes combinations of hardware and software that are operable to, among other things, control the operation of the battery pack 300, monitor a condition of the battery pack 300, enable or disable charging of the battery pack 300, enable or disable discharging of the battery pack 300, etc.

The battery pack controller 400 includes a plurality of electrical and electronic components that provide power, operational control, and protection to the components and modules within the battery pack controller 400 and/or the battery pack 300. For example, the battery pack controller 400 includes, among other things, a processing unit 435 (e.g., a microprocessor, a microcontroller, or another suitable programmable device), a memory 440, input units 445, and output units 450. The processing unit 435 includes, among other things, a control unit 455, an arithmetic logic unit (“ALU”) 460, and a plurality of registers 465 (shown as a group of registers in FIG. 4), and is implemented using a known computer architecture (e.g., a modified Harvard architecture, a von Neumann architecture, etc.). The processing unit 435, the memory 440, the input units 445, and the output units 450, as well as the various modules or circuits connected to the battery pack controller 400, are connected by one or more control and/or data buses (e.g., common bus 470). The control and/or data buses are shown generally in FIG. 4 for illustrative purposes. The use of one or more control and/or data buses for the interconnection between and communication among the various modules, circuits, and components would be known to a person skilled in the art in view of the embodiments described herein.

The memory 440 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 435 is connected to the memory 440 and executes software instructions that are capable of being stored in a RAM of the memory 440 (e.g., during execution), a ROM of the memory 440 (e.g., on a generally permanent basis), or another non-transitory computer readable medium such as another memory or a disc. Software included in the implementation of the battery pack 300 can be stored in the memory 440 of the battery pack controller 400. The software includes, for example, firmware, one or more applications, program data, filters, rules, one or more program modules, and other executable instructions. The battery pack controller 400 is configured to retrieve from the memory 440 and execute, among other things, instructions related to the control processes and methods described herein. In other constructions, the battery pack controller 400 includes additional, fewer, or different components.

The interface 410 includes a combination of mechanical components (e.g., rails, grooves, latches, etc.) and electrical components (e.g., one or more terminals) configured to and operable for interfacing (e.g., mechanically, electrically, and communicatively connecting) the battery pack 300 with another device (e.g., a power tool, a battery pack charger, the lawnmower 100, etc.). For example, the interface 410 is configured to receive power via a power line between the one or more battery cells 405 and the interface 410. The interface 410 is also configured to communicatively connect to the battery pack controller 400.

The one or more voltage sensors 415 are configured to, for example, monitor a voltage of the one or more battery cells 405, a voltage provided via the interface 410, or the like. The one or more current sensors 420 are configured to, for example, monitor a current provided by the battery cells 405 through the interface 410. The one or more temperature sensors 425 are configured to, for example, monitor a temperature of the battery cells 405.

During operation of the lawnmower 100, the one or more wheels 112 may lift from the ground due to bumpy terrain or user operation. Such “hopping conditions” or “hopping events” impact operation of the motor 280 as the lawnmower experiences a shift in experienced load. Particularly, the one or more wheels 112 losing contact with the ground can cause a cycle of acceleration and deceleration. Additionally, the amplitude of the acceleration and deceleration cycle may increase as the hopping condition repeats. This cycle can lead to excessive torque loads on the transmission/drive system. If the controller 200 does not respond to this hopping phenomenon, the lawnmower 100 may experience damage or failure of the transmission/drive system.

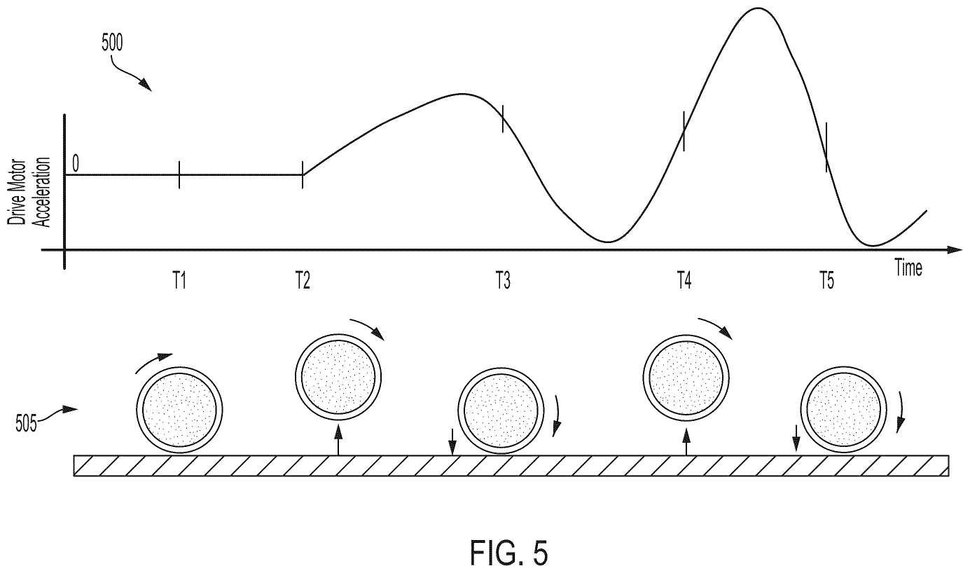

FIG. 5 illustrates a schematic representation of a wheel hopping phenomenon 505 accompanied by a corresponding line graph 500 depicting motor acceleration versus time. At time T1, all of the one or more wheels 112 are on the ground, and the motor 280 does not accelerate (acceleration of the motor 280 is equal to zero). At time T2, at least one of the one or more wheels 112 “hops” off the ground and the lawnmower 100 experiences a hopping condition. As a result, the motor 280 begins to accelerate. At time T3, the one or more wheels 112 return to the ground, and the motor 280 begins to deaccelerate. At time T4, at least one of the one or more wheels 112 “hops” off the ground again. As a result, the motor 280 begins to accelerate at a greater value than the acceleration experienced from times T2 to T3. At time T5, the one or more wheels 112 return to the ground, and the motor 280 once again deaccelerates.

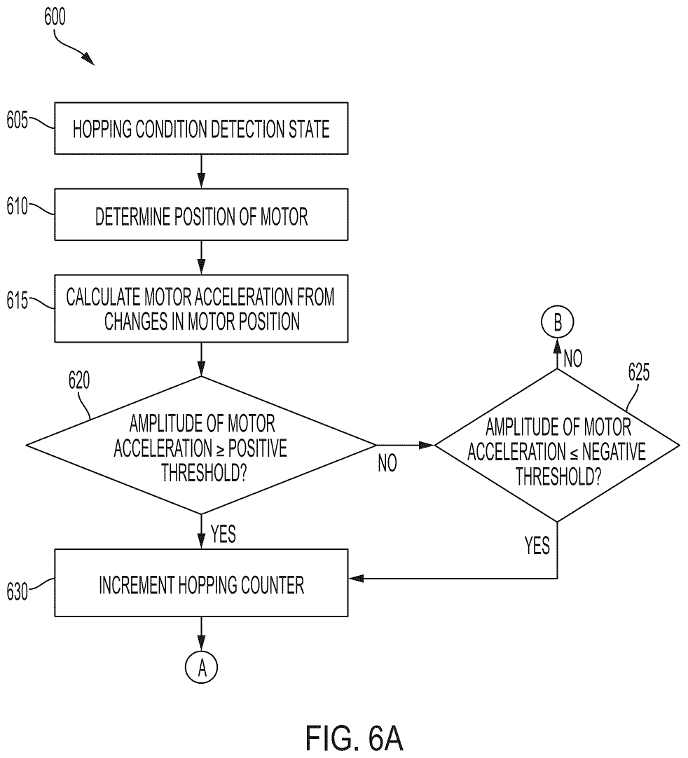

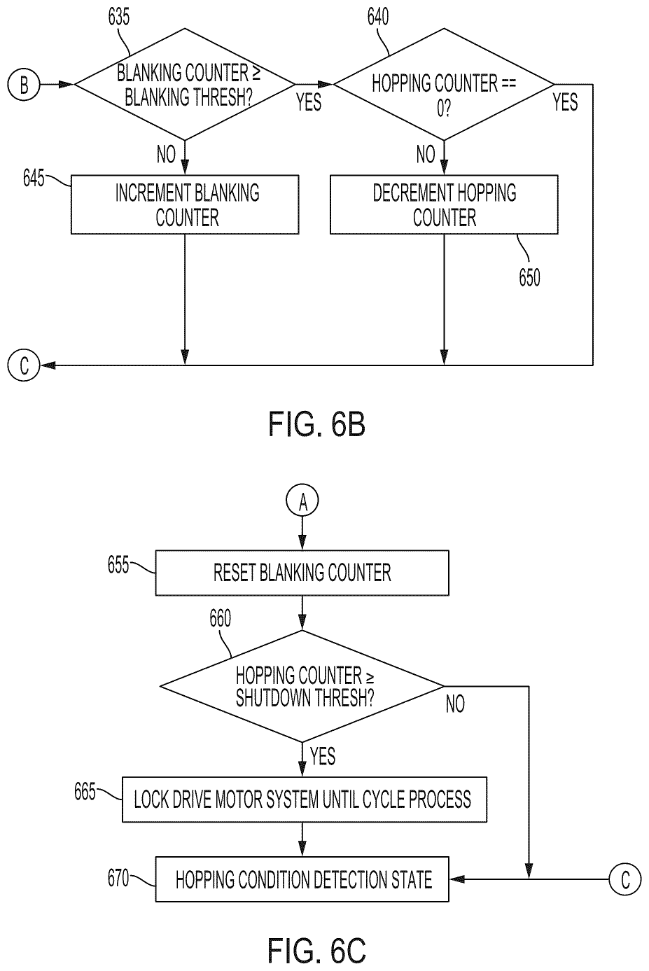

FIGS. 6A-6B provide a method 600 for an acceleration amplitude-based detection of a wheel hopping event (e.g., a hopping condition), according to some embodiments. While the method 600 is described as being performed by the controller 200, in some instances, the method 600 is performed by the battery pack controller 400 or a combination of the controller 200 and the battery pack controller 400. Various steps described herein with respect to the method 600 are capable of being executed simultaneously, in parallel, or in an order that differs from the illustrated serial and iterative manner of execution.

At block 605, the controller 200 is in a hopping condition detection state. While in the hopping condition detection state, the controller 200 monitors characteristics of the motor 280 such as motor position, motor velocity, motor acceleration, or a combination thereof. At block 610, the controller 200 determines a position of the motor 280. For example, the controller 200 receives a position signal from the position sensor 265 indicative of the position of the motor 280. At block 615, the controller 200 calculates the motor acceleration based on changes in (e.g., a derivative of) the position of the motor 280. In some embodiments, rather than determining the position of the motor 280 (at block 610), the controller 200 receives the acceleration of the motor 280 directly from the position sensor 265 (e.g., in situations where the position sensor 265 functions as an accelerometer).

At block 620, the controller 200 determines whether the amplitude of the motor acceleration is greater than or equal to a positive threshold. When the amplitude of the motor acceleration is greater than or equal to the positive threshold (at block 620), the controller 200 proceeds to block 630 and increments (e.g., adds 1 to) a hopping counter. When the amplitude of the motor acceleration is less than the positive threshold (at block 620), the controller 200 proceeds to block 625.

At block 625, the controller 200 determines whether the amplitude of the motor acceleration is less than or equal to (e.g., is beyond) a negative threshold. When the amplitude of the motor acceleration is less than or equal to the negative threshold (at block 625), the controller 200 proceeds to block 630 and increments the hopping counter. After incrementing the hopping counter, the controller 200 proceeds to block 655 (in FIG. 6C). When the amplitude of the motor acceleration is greater than a negative threshold (at block 625), the controller 200 proceeds to block 635 (in FIG. 6B).

At block 635, the controller 200 determines whether a blanking counter is greater than or equal to a blanking threshold. When the blanking counter is less than the blanking threshold, the controller 200 proceeds to block 645 and increments the blanking counter. Once the blanking counter is incremented, the controller 200 proceeds to block 670 (in FIG. 6C). When the blanking counter is greater than or equal to the blanking threshold (at block 635), the controller 200 proceeds to block 640.

At block 640, the controller 200 determines whether the hopping counter is equal to zero. When the hopping counter is not equal to zero, the controller 200 proceeds to block 650 and decrements the hopping counter. Once the hopping counter is decremented, the controller 200 proceeds to block 670 (in FIG. 6C). When the hopping counter is equal to zero (at block 640), the controller 200 proceeds to block 670.

After incrementing the hopping counter at block 630 (in FIG. 6A), the controller 200 proceeds to block 655 (in FIG. 6C) and resets the blanking counter. At block 660, the controller 200 determines whether the hopping counter is greater than or equal to a shutdown threshold. When the hopping counter is greater than or equal to the shutdown threshold, the controller 200 proceeds to block 665 and locks driving of the motor 280, until a cycling process has occurred (e.g., the lawnmower 100 is shut down and turned back on). In some embodiments, at block 655, the controller 200 disconnects the motor 280 or otherwise disables operation of the motor 280 until the lawnmower 100 is cycled by an operator. In some instances, rather than cycling the power of the entire lawnmower 100, the controller 200 locks driving of the motor 280 until a cycle of a user interface responsible for drive control of the lawnmower 100, such as the user interface 252. When the controller 200 locks operation of the motor 280, the controller 200 may provide an indication of the user interface 252 to cycle power of the lawnmower 100 or cycle the user interface 252 itself (e.g., powering off and on the user interface 252, selecting a “cycle” option displayed on the user interface 252, or the like).

After the lawnmower 100 (or the user interface 252) is cycled, the controller 200 enables normal operation of the motor 280 and proceeds to block 670. When the hopping counter is less than the shutdown threshold, or after cycling of the lawnmower 100, the controller 200 proceeds to block 670. At block 670, the controller 200 is in the hopping condition detection state. In some embodiments, at block 670, the controller 200 returns to block 610 and continues to monitor the position of the motor 280.

In some embodiments, the controller 200 determines the motor acceleration amplitude (at block 620) every millisecond or every few milliseconds. When motor acceleration or deceleration is beyond the positive threshold or the negative threshold, the hopping counter is incremented. Should the hopping counter satisfy a hopping threshold (at block 660), the drive system is shut off until a cycling operation (at block 665). However, if a hopping event is not detected for a period of time defined by the blanking counter, the hopping counter is decremented back down to zero. In some embodiments, this decrementing occurs by one count every millisecond. By implementing both a hopping counter and a blanking counter, the controller 200 avoids preemptively shutting down the motor 280.

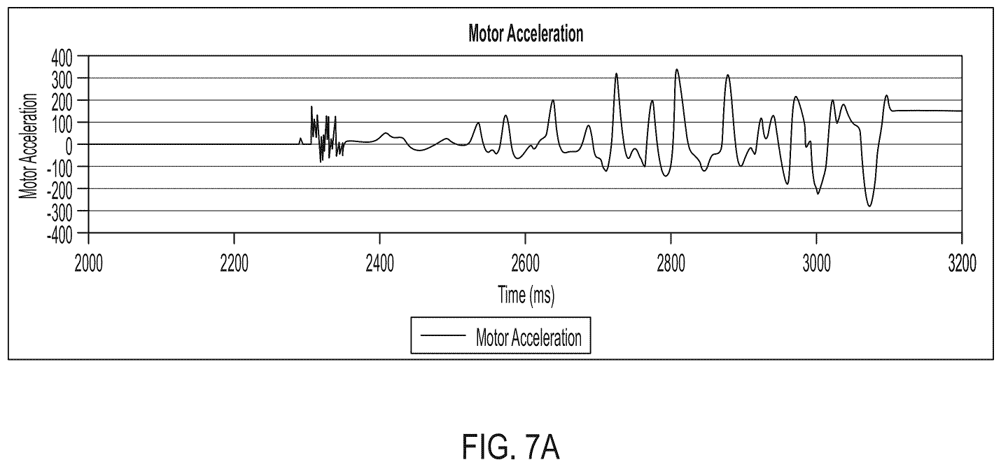

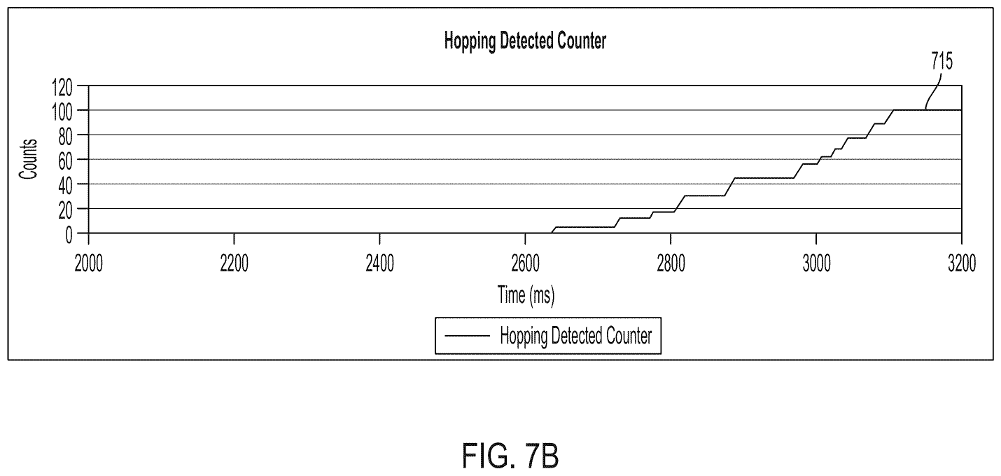

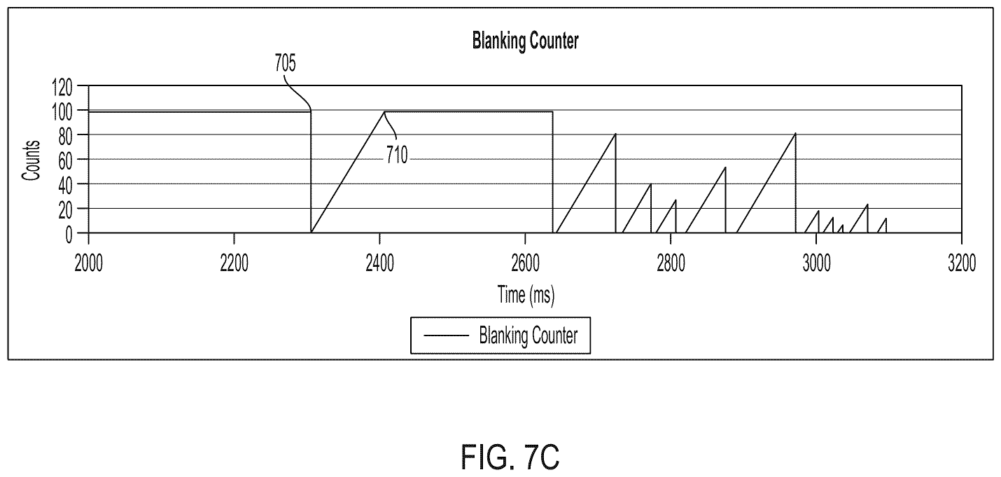

FIGS. 7A-7C provide line graphs illustrating the motor acceleration, the hopping counter, and the blanking counter corresponding to the same example testing data over a period of time. At approximately 2300 ms (at event 705 in FIG. 7C), a first motor acceleration event is detected to be above a threshold value, and the blanking counter resets to zero. As the motor acceleration amplitude begins to decrease, the blanking counter ends and the hopping counter is decremented at approximately 2400 ms (at event 710 in FIG. 7C). Subsequently, the motor acceleration begins to exhibit greater and greater amplitudes in FIG. 7A from approximately 2600 ms to 3100 ms. At approximately 3100 ms, the hopping counter reaches a threshold value and shuts off, disconnects, or otherwise disables the drive system and/or the motor 280 (at event 715 in FIG. 7B).

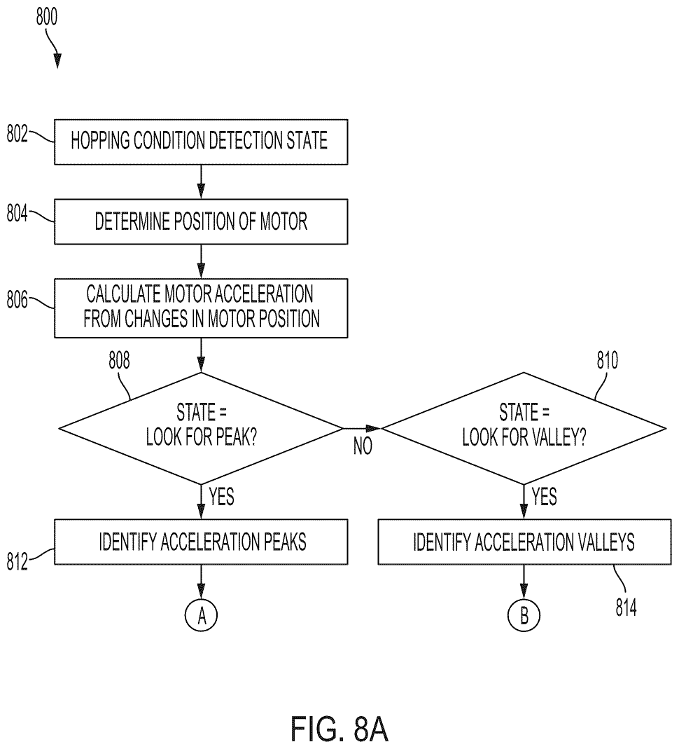

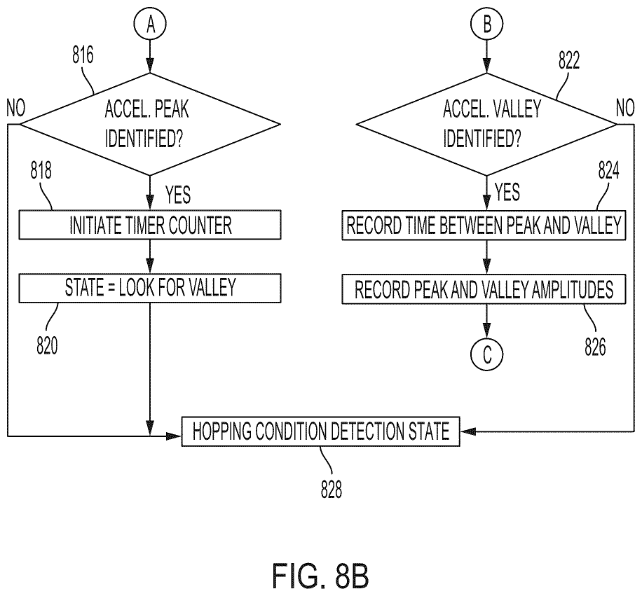

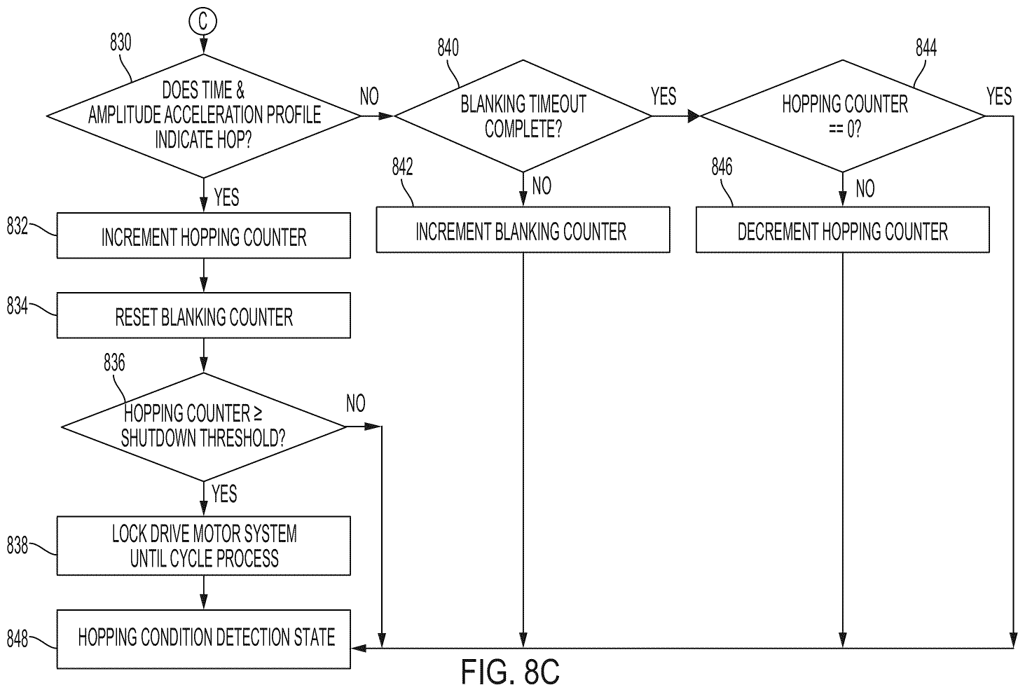

FIGS. 8A-8C provide another example method 800 for an acceleration amplitude-based detection of a wheel hopping event (e.g., a hopping condition), according to some embodiments. The method 800 combines a peak and valley detector with a timer to measure the time between acceleration peaks and acceleration valleys. The method 800 may use fewer hopping cycles than the method 600 to establish that a hopping condition is occurring. While the method 800 is described as being performed by the controller 200, in some instances, the method 800 is performed by the battery pack controller 400 or a combination of the controller 200 and the battery pack controller 400. Various steps described herein with respect to the method 800 are capable of being executed simultaneously, in parallel, or in an order that differs from the illustrated serial and iterative manner of execution.

At block 802, the controller 200 is in a hopping condition detection state. While in the hopping condition detection state, the controller 200 monitors characteristics of the motor 280 such as motor position, motor velocity, motor acceleration, or a combination thereof. At block 804, the controller 200 determines a position of the motor 280. For example, the controller 200 receives a position signal from the position sensor 265 indicative of the position of the motor 280. At block 806, the controller 200 calculates the motor acceleration based on changes in (e.g., a derivative of) the position of the motor 280. In some embodiments, rather than determining the position of the motor 280 (at block 804), the controller 200 receives the acceleration of the motor 280 directly for the position sensor 265 (e.g., in situations where the position sensor 265 functions as an accelerometer).

At block 808, the controller 200 determines, based on a state of the system (e.g., a position of the motor 280, an acceleration of the motor 280, etc.), whether to look for an acceleration peak. When the state of the system indicates to look for an acceleration peak (e.g., a “Look For Peak” state), the controller 200 proceeds to block 812 and begins to identify acceleration peaks. When the state of the system does not indicate to look for acceleration peaks (at block 808), the controller 200 proceeds to block 810 and determines, based on a state of the system, whether to look for an acceleration valley. When the state of the system indicates to look for an acceleration valley (e.g., a “Look For Valley” state), the controller 200 proceeds to block 814 and begins to identify acceleration valleys.

Following the controller 200 determining to identify acceleration peaks (at block 812) and with reference to FIG. 8B, at block 816, the controller 200 determines whether an acceleration peak is identified. For example, the controller 200 may analyze a derivative of the motor acceleration to identify a peak in the motor acceleration. In some embodiments, when the derivative of the motor acceleration is approximately zero following the derivative having a positive number, a peak is identified. When an acceleration peak is not identified, the controller 200 proceeds to block 828 and continues operating in the hopping condition detection state (e.g., returns to block 802).

When an acceleration peak is identified, the controller 200 proceeds to block 818. At block 818, the controller 200 initiates a timer counter. At block 820, the controller 200 sets the state of the system to a “Look For Valley” state. The controller 200 then proceeds to block 828 and continues operating in the hopping condition detection state.

Now following the controller 200 determining to identify acceleration valleys (at block 814) and with reference to FIG. 8B, at block 822, the controller 200 determines whether an acceleration valley is identified. For example, the controller 200 may analyze a derivative of the motor acceleration to identify a valley in the motor acceleration. In some embodiments, when the derivative of the motor acceleration is approximately zero following the derivative having a negative number, a valley is identified. When an acceleration valley is not identified, the controller 200 proceeds to block 828 and continues operating in the hopping condition detection state.

When an acceleration valley is identified, the controller 200 proceeds to block 824. At block 824, the controller 200 records the time between the acceleration peak and the acceleration valley. For example, the controller 200 determines a value of the timer counter and stores the value in the memory 225. At block 826, the controller 200 records the amplitude of the acceleration peak and the amplitude of the acceleration valley. For example, the controller 200 stores the amplitude of the acceleration peak and the amplitude of the acceleration valley in the memory 225. In some embodiments, the controller 200 records the difference between the acceleration peak and the acceleration valley. The time counter, the amplitude of the acceleration peak, and the amplitude of the acceleration valley form an amplitude profile. In some embodiments, the controller 200 constructs the amplitude profile using the time counter, the amplitude of the acceleration peak, and the amplitude of the acceleration valley. After recording the timer counter, the amplitude of the acceleration peak, and the amplitude of the acceleration valley, the controller 200 proceeds to block 830.

At block 830 (and with reference to FIG. 8C), the controller 200 determines whether the time counter and the amplitudes of the acceleration peak and acceleration valley indicate a hopping condition. For example, the controller 200 compares the recorded amplitude profile with data profiles of a known and/or a predetermined hopping condition. The data profiles of the known and/or predetermined hopping condition may be stored in the memory 225. In some embodiments, the data profiles of the known and/or predetermined hopping condition are designated by a manufacturer. In other embodiments, the data profiles of the known and/or predetermined hopping condition are created by the controller 200 based on past information captured during prior operation of the lawnmower 100 and stored in the memory 225, such that the controller 200 can update the data profile to account for sensor degradation and/or other part wear over the operational lifetime of the lawnmower 100.

When the controller 200 determines that the time counter and the amplitudes of the acceleration peak and the acceleration valley do indicate a hopping condition, the controller 200 proceeds to block 832. At block 832, the controller 200 increments (e.g., adds 1 to) a hopping counter. At block 834, the controller 200 resets a blanking counter.

At block 836, the controller 200 determines whether the hopping counter is greater than or equal to a shutdown threshold. When the hopping counter is greater than or equal to the shutdown threshold, the controller 200 proceeds to block 838 and locks driving of the motor 280, until a cycling process has occurred (e.g., the lawnmower 100 is shut down and turned back on). In some embodiments, at block 838, the controller 200 disconnects the motor 280 or otherwise disables operation of the motor 280 until the lawnmower 100 (or the user interface 252) is cycled by an operator. After the lawnmower 100 is cycled, the controller 200 enables normal operation of the motor 280 and proceeds to block 848.

When the hopping counter is less than the shutdown threshold, or after cycling of the lawnmower 100, the controller 200 proceeds to block 848. At block 848, the controller 200 is in the hopping condition detection state. In some embodiments, at block 848, the controller 200 returns to block 804 and continues to monitor the position of the motor 280.

Returning to block 830, when the controller 200 determines that the time counter and the amplitudes of the acceleration peak and the acceleration valley do not indicate a hopping condition, the controller 200 proceeds to block 840. At block 840, the controller 200 determines whether the blanking counter is greater than or equal to a blanking threshold. When the blanking counter is less than the blanking threshold, the controller 200 proceeds to block 842 and increments the blanking counter. Once the blanking counter is incremented, the controller 200 proceeds to block 848. When the blanking counter is greater than or equal to the blanking threshold (at block 840), the controller 200 proceeds to block 844.

At block 844, the controller 200 determines whether the hopping counter is equal to zero. When the hopping counter is not equal to zero, the controller 200 proceeds to block 846 and decrements the hopping counter. Once the hopping counter is decremented, the controller 200 proceeds to block 848. When the hopping counter is equal to zero (at block 844), the controller 200 proceeds to block 848.

In some embodiments, instead of shutting down/off, disconnecting, or otherwise disabling the drive system or motor 280 at block 838, a fast responding PID controller is used to actively counter the wheel hopping phenomenon. Instead of shutting down, for instance, the power applied to the motor 280 may be rapidly adjusted to counter the acceleration and deceleration cycle that occurs when one or more wheels 112 leave the ground and then regain contact with the ground. This active countering of the wheel hopping phenomenon may reduce or eliminate the torque spikes experienced by the drive system and may aid the lawnmower 100 in regaining traction upon resuming contact between the one or more wheels 112 and the ground.

While embodiments provided herein have primarily referred to a locking of driving the motor 280 when a hopping condition is detected, in some embodiments, the controller 200 instead adjusts an amount of power provided to the motor 280. For example, when the hopping counter exceeds the shutdown threshold, the controller 200 may reduce a current provided to the motor 280, reduce a voltage provided to the motor 280, reduce a duty cycle of a pulse-width-modulated (PWM) signal used to drive the switching network 255, or a combination thereof. The controller 200 may continue to provide the reduced power to the motor 280 until either the lawnmower 100 experiences a power cycle or until the controller 200 detects an end of the hopping condition.

Thus, the present disclosure provides a control system, a series of operational instructions stored in a tangible medium, a lawnmower, and a method of operation relating to drive system hopping detection and control. These embodiments described herein may, among other things, extend the usable life of a lawnmower, increase safety to the user, improve operation of the lawnmower, or the like.

Although the disclosure has been described in detail with reference to certain preferred embodiments, variations and modifications exist within the scope and spirit of one or more independent aspects of the disclosure as described.

What is claimed is:

1. A walk-behind lawnmower comprising:
a lawnmower housing;
one or more wheels;
one or more cutting blades;
a motor configured to rotate the one or more wheels;
a sensor configured to sense an acceleration of the motor; and
a controller coupled to the motor and the sensor, the controller configured to:
receive, from the sensor, a signal indicative of the acceleration of the motor,
determine, based on the signal, whether an amplitude of the acceleration of the motor is greater than or equal to an amplitude threshold,
increment, in response to the amplitude being greater than or equal to the amplitude threshold, a hopping counter,
determine whether the hopping counter is greater than or equal to a hopping threshold, and
disable, in response to the hopping counter being greater than or equal to the hopping threshold, operation of the motor.

2. The walk-behind lawnmower of claim 1, wherein the controller is configured to determine whether the amplitude of the acceleration of the motor is greater than or equal to the amplitude threshold by:
determining whether the amplitude of the acceleration of the motor is greater than or equal to a positive threshold, and
determining whether the amplitude of the acceleration of the motor is less than or equal to a negative threshold.

3. The walk-behind lawnmower of claim 1, wherein the controller is further configured to:
determine, in response to the amplitude being less than the amplitude threshold, whether a blanking counter is greater than or equal to a blanking threshold, and
decrement, in response to the blanking counter being greater than or equal to the blanking threshold, the hopping counter.

4. The walk-behind lawnmower of claim 3, wherein the controller is further configured to:
increment, in response to the blanking counter being less than the blanking threshold, the blanking counter.

5. The walk-behind lawnmower of claim 3, wherein the controller is further configured to:
reset, in response to the amplitude being greater than or equal to the amplitude threshold, the blanking counter.

6. The walk-behind lawnmower of claim 1, wherein the controller is further configured to:
enable, in response to a power cycle of the lawnmower, operation of the motor.

7. The walk-behind lawnmower of claim 1, further including a battery pack configured to provide power to the motor, and wherein the controller is configured to disable operation of the motor by disconnecting the motor from the battery pack.

8. A method of operating a walk-behind lawnmower, the method comprising:
receiving, from a sensor, a signal indicative of an acceleration of a motor,
determining, based on the signal, whether an amplitude of the acceleration of the motor is greater than or equal to an amplitude threshold,
incrementing, in response to the amplitude being greater than or equal to the amplitude threshold, a hopping counter,
determining whether the hopping counter is greater than or equal to a hopping threshold, and
disabling, in response to the hopping counter being greater than or equal to the hopping threshold, operation of the motor.

9. The method of claim 8, wherein determining whether the amplitude of the acceleration of the motor is greater than or equal to the amplitude threshold includes:
determining whether the amplitude of the acceleration of the motor is greater than or equal to a positive threshold, and
determining whether the amplitude of the acceleration of the motor is less than or equal to a negative threshold.

10. The method of claim 8, further comprising:
determining, in response to the amplitude being less than the amplitude threshold, whether a blanking counter is greater than or equal to a blanking threshold, and
decrementing, in response to the blanking counter being greater than or equal to the blanking threshold, the hopping counter.

11. The method of claim 10, further comprising:
incrementing, in response to the blanking counter being less than the blanking threshold, the blanking counter.

12. The method of claim 10, further comprising:
resetting, in response to the amplitude being greater than or equal to the amplitude threshold, the blanking counter.

13. The method of claim 8, further comprising:
enabling, in response to a power cycle of the lawnmower, operation of the motor.

14. The method of claim 8, wherein disabling operation of the motor includes:
disconnecting the motor from a battery pack.

15. A walk-behind lawnmower comprising:
a lawnmower housing;
one or more wheels;
one or more cutting blades;
a motor configured to rotate the one or more wheels;
a sensor configured to sense an acceleration of the motor; and
a controller coupled to the motor and the sensor, the controller configured to:
receive, from the sensor, a signal indicative of the acceleration of the motor,
determine, based on the signal, an acceleration amplitude profile,
determine whether the acceleration amplitude profile indicates a hopping condition of the one or more wheels,
increment, in response to the acceleration amplitude profile indicating the hopping condition of the one or more wheels, a hopping counter,
determine whether the hopping counter is greater than or equal to a hopping threshold, and
disable, in response to the hopping counter being greater than or equal to the hopping threshold, operation of the motor.

16. The walk-behind lawnmower of claim 15, wherein the controller is configured to determine the amplitude profile by:
identifying, based on the signal, an acceleration peak,
initiating, in response to identifying the acceleration peak, a timer counter,
identifying, after identifying the acceleration peak, an acceleration valley,
recording a time between the acceleration peak and the acceleration valley based on the timer counter, and
constructing the amplitude profile based on the time between the acceleration peak and the acceleration valley, a value of the acceleration peak, and a value of the acceleration valley.

17. The walk-behind lawnmower of claim 15, wherein the controller is further configured to:
determine, in response to the acceleration amplitude profile not indicating the hopping condition of the one or more wheels, whether a blanking counter is greater than or equal to a blanking threshold, and
decrement, in response to the blanking counter being greater than or equal to the blanking threshold, the hopping counter.

18. The walk-behind lawnmower of claim 17, wherein the controller is further configured to:
increment, in response to the blanking counter being less than the blanking threshold, the blanking counter.

19. The walk-behind lawnmower of claim 17, wherein the controller is further configured to:
reset, in response to the acceleration amplitude profile indicating the hopping condition of the one or more wheels, the blanking counter.

20. The walk-behind lawnmower of claim 15, further including a battery pack configured to provide power to the motor, and wherein the controller is configured to disable operation of the motor by disconnecting the motor from the battery pack.

21. The walk-behind lawnmower of claim 15, wherein the controller is further configured to:
enable, in response to a cycle of one or more user interfaces responsible for the drive control of the lawnmower, operation of the motor.
